(19) United States
(12) Patent Application Publication
(10) Pub. No.: US 2004/0077339 A1
(43) Pub. Date: Apr. 22, 2004

(54) Forced cell phone call disruption device

(76) Inventor: Stephen W. Martens, Rosedale (CA)

Correspondence Address: GRAYBEAL, JACKSON, HALEY LLP, 155 - 108TH AVENUE NE, SUITE 350, BELLEVUE, WA, 98004-5901, US

(21) Appl. No.: 10/273,597

(22) Filed: Oct. 18, 2002

(51) Int. Cl. H04M 1/00

(52) U.S. Cl. 455/414.1; 455/420; 455/1; 455/456.4

(57) ABSTRACT

A wireless cell phone blocker that would prevent the driver of a motor vehicle from placing or receiving a cell phone call. The invention would be mounted in the vehicle and contain circuitry that would broadcast a short-range signal that would block operation of a cell phone inside the vehicle.

### BACKGROUND OF THE INVENTION

1. Field of the Invention

The present invention relates to a forced cell phone call disruption device for use in connection with cell phone accessories. The forced cell phone call disruption device has particular utility in connection with forced cell phone disruption device using the vehicle transmission as the switch.

2. Description of the Prior Art

Forced cell phone call disruption devices are desirable for reducing the number of cell phone calls which are taken while a user is driving a vehicle. Current statistics show that the automobile accident rate while using a cell phone is much higher than the average rate. A forced restriction of cell phone use during driving may be the only viable solution. A need was felt for a forced cell phone call disruption device that uses the state of the transmission as the gating switch for cell phone use.

The use of cell phone accessories is known in the prior art. For example, U.S. Pat. No. 5,819,171 to Hoogerwerf discloses an automated forced call disruption for use with wireless telephone systems that provide the ability to disrupt normal completion of a specific call made through a wireless telephone system. The specified call can be forced to be immediately ended, re-routed immediately to a selectable destination, or linked to a local voice frequency interface. The disruption of the call can occur at any point in time over the duration of the call. The decision to disrupt the call, as well as which action to take against the call, can be selected manually by a human or automatically through a standard data interface provided. The call disruption apparatus can be interfaced to the wireless system through a circuit physically connected to the wireless telephone system equipment, or through a modulated radio frequency interface. However, the Hoogerwerf, et al. '171 patent does not use the transmission as a switch to turn the call disruption on and off.

Similarly, U.S. Pat. No. 6,222,458 to Harris discloses an automatic cell phone detection at a combustible delivery station that provides protection against use of a two way radio, e.g. a cellular phone, at a combustible delivery station. One mode is active, and detects operating cell phones at the gas station. The phones can be detected using Bluetooth. The pump can be turned off when the alarm is detected. Another mode is passive. This mode can be via shielding, alone or with RF jamming. However, the Harris '458 patent does not use the transmission as a switch to turn the call disruption on and off.

Lastly, U.S. Pat. No. 5,442,805 to Sagers, et al. discloses a location-based adaptive radio control that provides for a radio having adjustable operating parameters to adjust at least one such adjustable operating parameter based on the current location of the radio. Operating parameters which may be so adjusted include, but are not limited to, the following: transmitting power, operating channel, operating band, modulation type, modulation index, frequency deviation, squelch setting, channel spacing, control channel (for trunked communications), noise blanker characteristic, and receive bandwidth. In another embodiment, transmissions by the radio can be inhibited as a function of the location when it is determined that the location is within a hazard area. However, the Sagers , et al. '805 patent does not use the transmission as a switch to turn the call disruption on and off.

While the above-described devices fulfill their respective, particular objectives and requirements, the aforementioned patents do not describe a forced cell phone call disruption device that allows forced cell phone disruption device using the vehicle transmission as the switch. The Hoogerwerf, et al. '171, Harris '458 and Sagers, et al. '805 patents make no provision for using the transmission as a switch to turn the call disruption on and off.

Therefore, a need exists for a new and improved forced cell phone call disruption device which can be used for forced cell phone disruption device using the vehicle transmission as the switch. In this regard, the present invention substantially fulfills this need. In this respect, the forced cell phone call disruption device according to the present invention substantially departs from the conventional concepts and designs of the prior art, and in doing so provides an apparatus primarily developed for the purpose of forced cell phone disruption device using the vehicle transmission as the switch.

### SUMMARY OF THE INVENTION

In view of the foregoing disadvantages inherent in the known types of cell phone accessories now present in the prior art, the present invention provides an improved forced cell phone call disruption device, and overcomes the above-mentioned disadvantages and drawbacks of the prior art. As such, the general purpose of the present invention, which will be described subsequently in greater detail, is to provide a new and improved forced cell phone call disruption device and method which has all the advantages of the prior art mentioned heretofore and many novel features that result in a forced cell phone call disruption device which is not anticipated, rendered obvious, suggested, or even implied by the prior art, either alone or in any combination thereof.

To attain this, the present invention essentially comprises a jammer capable of jamming a cell phone signal. A gear selector switch is electrically connected to the jammer. The gear selector switch is connected to a vehicle gear selector. The gear selector switch is capable of selectively powering off the jammer when the vehicle gear selector is in a park position.

There has thus been outlined, rather broadly, the more important features of the invention in order that the detailed description thereof that follows may be better understood and in order that the present contribution to the art may be better appreciated.

The invention may also include a keypad, a control unit and an ignition switch. There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved forced cell phone call disruption device that has all of the advantages of the prior art cell phone accessories and none of the disadvantages.

It is another object of the present invention to provide a new and improved forced cell phone call disruption device that may be easily and efficiently manufactured and marketed.

An even further object of the present invention is to provide a new and improved forced cell phone call disruption device that has a low cost of manufacture with regard to both materials and labor, and which accordingly is then susceptible of low prices of sale to the consuming public, thereby making such forced cell phone call disruption device economically available to the buying public.

Still another object of the present invention is to provide a new forced cell phone call disruption device that provides in the apparatuses and methods of the prior art some of the advantages thereof, while simultaneously overcoming some of the disadvantages normally associated therewith.

Even still another object of the present invention is to provide a forced cell phone call disruption device uses the vehicle transmission as the gating switch.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a wiring diagram view of the preferred embodiment of the forced cell phone call disruption device constructed in accordance with the principles of the present invention.

FIG. 2 is a block diagram view of the forced cell phone call disruption device of the present invention.

The same reference numerals refer to the same parts throughout the various figures.

### DESCRIPTION OF THE PREFERRED EMBODIMENT

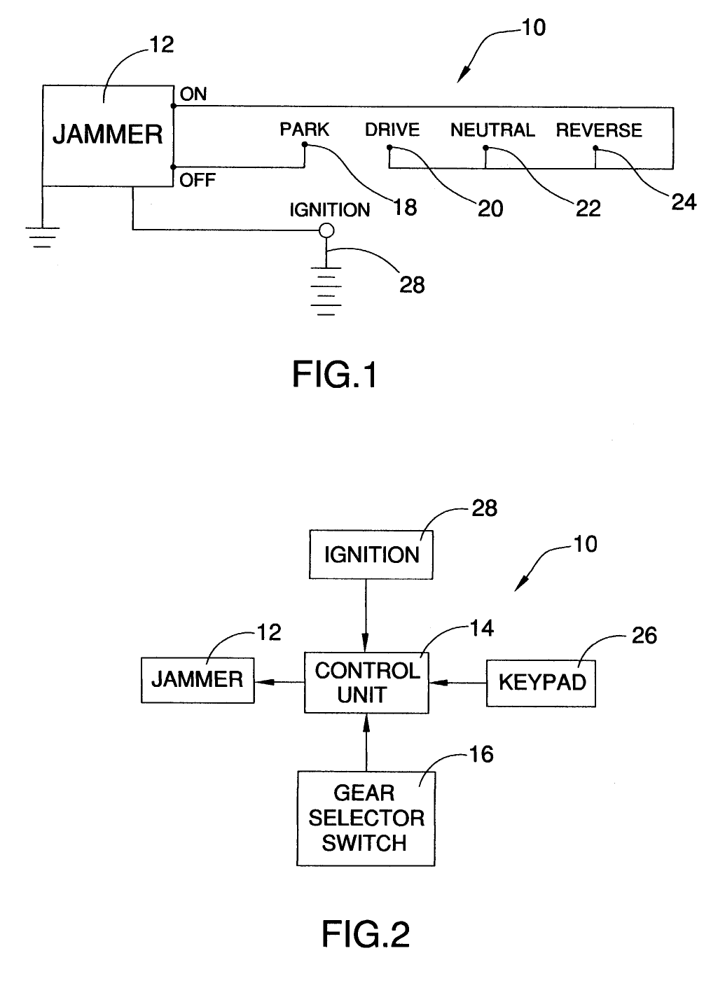

Referring now to the drawings, and particularly to FIGS. 1-2, a preferred embodiment of the forced cell phone call disruption device of the present invention is shown and generally designated by the reference numeral 10.

In FIG. 1, a new and improved forced cell phone call disruption device 10 of the present invention for forced cell phone disruption device using the vehicle transmission as the switch is illustrated and will be described. More particularly, the forced cell phone call disruption device 10 has a jammer 12 is capable of jamming the cell phone signal. A control unit 14 (shown in FIG. 2) is electrically connected to the jammer 12. The control unit 14 is capable of selectively powering on and selectively powering off the jammer 12. A gear selector switch 16 is electrically connected to the control unit 14. The gear selector switch 16 is connected to the vehicle gear selector. The gear selector switch 16 is capable of selectively commanding the control unit 14 to power off the jammer 12 when the vehicle gear selector is in a park position 18. The gear selector switch 16 is capable of selectively powering on the jammer 12 when the vehicle gear selector is in a drive position 20. The gear selector switch 16 is capable of selectively powering on the jammer 12 when the vehicle gear selector is in a neutral position 22. The gear selector switch 16 is capable of selectively powering on the jammer 12 when the vehicle gear selector is in a reverse position 24. An ignition switch 28 is electrically connected to the control unit 14. The ignition switch 28 is capable of being turned off. The ignition switch 28 is capable of commanding the control unit 14 to power off the jammer 12 when the ignition switch 28 is turned off.

In FIG. 2, the forced cell phone call disruption device 10 is illustrated and will be described. The forced cell phone call disruption device 10 has the jammer 12 that is capable of jamming the cell phone signal. The control unit 14 is electrically connected to the jammer 12. The control unit 14 is capable of selectively powering on and selectively powering off the jammer 12. The gear selector switch 16 is electrically connected to the control unit 14. The gear selector switch 16 is connected to the vehicle gear selector. A keypad 26 is electrically connected to the control unit 14. The keypad 26 is capable of being switched off. The keypad 26 is capable of commanding the control unit 14 to power off the jammer 12 when the keypad 26 is switched off. The ignition switch 28 is electrically connected to the control unit 14. The ignition switch 28 is capable of being turned off. The ignition switch 28 is capable of commanding the control unit 14 to power off the jammer 12 when the ignition switch 28 is turned off.

While a preferred embodiment of the forced cell phone call disruption device has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable wiring format may be used instead of the discrete component design described. And although forced cell phone disruption device using the vehicle transmission as the switch have been described, it should be appreciated that the forced cell phone call disruption device herein described is also suitable for use in any passenger vehicle.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A forced cell phone call disruption device comprising:
a jammer capable of jamming a cell phone signal; and
a gear selector switch electrically connected to said jammer, said gear selector switch connected to an vehicle gear selector, said gear selector switch capable of selectively powering off said jammer when said vehicle gear selector is in a park position.

2. The forced cell phone call disruption device of claim 1 further comprising:
a control unit electrically connected to said jammer, said control unit electrically connected to said gear selector switch, said control unit capable of selectively powering on and selectively powering off said jammer.

3. The forced cell phone call disruption device of claim 2 further comprising:
a keypad electrically connected to said control unit, said keypad capable of being switched off, said keypad is capable of commanding said control unit to power off said jammer when said keypad is switched off.

4. The forced cell phone call disruption device of claim 1 further comprising:
an ignition switch electrically connected to said control unit, said ignition switch capable of being turned off, said ignition switch is capable of commanding said control unit is to power off said jammer when said ignition switch is turned off.

5. The forced cell phone call disruption device of claim 1 wherein:
said gear selector switch is capable of selectively powering on said jammer when said vehicle gear selector is in a drive position.

6. The forced cell phone call disruption device of claim 1 wherein:
said gear selector switch is capable of selectively powering on said jammer when said vehicle gear selector is in a neutral position.

7. The forced cell phone call disruption device of claim 1 wherein:
said gear selector switch is capable of selectively powering on said jammer when said vehicle gear selector is in a reverse position.

8. The forced cell phone call disruption device of claim 1 wherein:
said jammer is an intelligent beacon disabler type.

9. The forced cell phone call disruption device of claim 1 wherein:
said jammer is an intelligent cellular disabler type.

10. The forced cell phone call disruption device of claim 1 wherein:
said jammer is direct receive and transmit type.

11. The forced cell phone call disruption device of claim 1 wherein:
said jammer is an electromagnetic shield type that is capable of selectively allowing transmission and reception of cell phone signals.

12. A forced cell phone call disruption device comprising:
a jammer capable of jamming a cell phone signal;
a control unit electrically connected to said jammer, said control unit capable of selectively powering on and selectively powering off said jammer; and
a gear selector switch electrically connected to said control unit, said gear selector switch connected to a vehicle gear selector, said gear selector switch capable of selectively commanding said control unit to power off said jammer when said vehicle gear selector is in a park position.

13. The forced cell phone call disruption device of claim 12 further comprising:
a keypad electrically connected to said control unit, said keypad capable of being switched off, said keypad is capable of commanding said control unit to power off said jammer when said keypad is switched off.

14. The forced cell phone call disruption device of claim 12 further comprising:
an ignition switch electrically connected to said control unit, said ignition switch capable of being turned off, said ignition switch is capable of commanding said control unit is to power off said jammer when said ignition switch is turned off.

15. The forced cell phone call disruption device of claim 12 wherein:
said gear selector switch is capable of selectively powering on said jammer when said vehicle gear selector is in a drive position;
said gear selector switch is capable of selectively powering on said jammer when said vehicle gear selector is in a neutral position; and
said gear selector switch is capable of selectively powering on said jammer when said vehicle gear selector is in a reverse position.

16. The forced cell phone call disruption device of claim 12 wherein:
said jammer is an intelligent beacon disabler type.

17. The forced cell phone call disruption device of claim 12 wherein:
said jammer is an intelligent cellular disabler type.

18. The forced cell phone call disruption device of claim 12 wherein:
said jammer is direct receive and transmit type.

19. The forced cell phone call disruption device of claim 12 wherein:
said jammer is an electromagnetic shield type that is capable of selectively allowing transmission and reception of cell phone signals.

20. A forced cell phone call disruption device comprising:
a jammer capable of jamming a cell phone signal;
a control unit electrically connected to said jammer, said control unit capable of selectively powering on and selectively powering off said jammer;
a gear selector switch electrically connected to said control unit, said gear selector switch connected to a vehicle gear selector, said gear selector switch capable of selectively commanding said control unit to power off said jammer when said vehicle gear selector is in a park position, said gear selector switch is capable of selectively powering on said jammer when said vehicle gear selector is in a drive position, said gear selector switch is capable of selectively powering on said jammer when said vehicle gear selector is in a neutral position, said gear selector switch is capable of selectively powering on said jammer when said vehicle gear selector is in a reverse position;
a keypad electrically connected to said control unit, said keypad capable of being switched off, said keypad is capable of commanding said control unit to power off said jammer when said keypad is switched off; and
an ignition switch electrically connected to said control unit, said ignition switch capable of being turned off, said ignition switch is capable of commanding said control unit is to power off said jammer when said ignition switch is turned off.
